(19) United States
(12) Patent Application Publication
(10) Pub. No.: US 2013/0052524 A1
(43) Pub. Date: Feb. 28, 2013

(54) ELECTROLYTIC SOLUTION, SECONDARY BATTERY, BATTERY PACK, ELECTRIC VEHICLE, ELECTRIC POWER STORAGE SYSTEM, ELECTRIC POWER TOOL, AND ELECTRONIC DEVICE

(71) Applicants: Ichiro Yamada, Fukushima (JP); Tadahiko Kubota, Kanagawa (JP)

(72) Inventors: Ichiro Yamada, Fukushima (JP); Tadahiko Kubota, Kanagawa (JP)

(73) Assignee: SONY CORPORATION, Tokyo (JP)

(21) Appl. No.: 13/584,439

(22) Filed: Aug. 13, 2012

(30) Foreign Application Priority Data
Aug. 26, 2011 (JP) 2011-184805

(51) Int. Cl. H01M 10/02

(52) U.S. Cl. 429/200; 429/188; 429/199

(57) ABSTRACT

A secondary battery includes: a cathode; an anode; and an electrolytic solution. The electrolytic solution includes an allene compound having a tetravalent skeleton represented by Formula (1) described below.

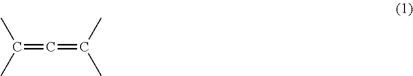

### CROSS REFERENCES TO RELATED APPLICATIONS

The present application claims priority to Japanese Priority Patent Application JP 2011-184805 filed in the Japan Patent Office on Aug. 26, 2011, the entire content of which is hereby incorporated by reference.

### BACKGROUND

The present application relates to an electrolytic solution, a secondary battery using the electrolytic solution, a battery pack using the secondary battery, an electric vehicle using the secondary battery, an electric power storage system using the secondary battery, an electric power tool using the secondary battery, and an electronic device using the secondary battery.

In recent years, various electronic devices such as a mobile phone and a personal digital assistant (PDA) have been widely used, and it has been strongly demanded to further reduce their size and weight and to achieve their long life. Accordingly, as an electric power source for the electronic devices, a battery, in particular, a small and light-weight secondary battery capable of providing high energy density has been developed. In these days, it has been considered to apply such a secondary battery to various applications represented by a battery pack attachably and detachably loaded on the electronic devices or the like, an electric vehicle such as an electric automobile, an electric power storage system such as a home electric power server, or an electric power tool such as an electric drill.

As the secondary battery, secondary batteries using various charge and discharge principles have been widely proposed. Specially, a secondary battery using insertion and extraction of an electrode reactant is considered promising, since such a secondary battery provides higher energy density than lead batteries, nickel cadmium batteries, and the like.

The secondary battery includes a cathode, an anode, and an electrolytic solution. The cathode contains a cathode active material capable of inserting and extracting the electrode reactant. The anode contains an anode active material capable of inserting and extracting the electrode reactant. The electrolytic solution contains a solvent and an electrolyte salt. In order to obtain a high battery capacity, as the solvent of the electrolytic solution, a mixed solvent of a cyclic ester carbonate as a high dielectric constant solvent and a chain ester carbonate as a low viscosity solvent and/or the like are used.

A composition of an electrolytic solution largely affects performance of a secondary battery. Therefore, various studies have been made on the composition. Specifically, it is proposed that a cyclic ester carbonate having an unsaturated carbon bond be used as a reactive cyclic ester carbonate to improve cycle characteristics and the like (for example, see Japanese Unexamined Patent Application Publication No. 2006-086058). One reason for this is, since a rigid film is formed on the surface of an anode in this case, a decomposition reaction of the electrolytic solution due to anode reactivity is suppressed. As the cyclic ester carbonate having an unsaturated carbon bond, vinylene carbonate and/or the like is used.

### SUMMARY

In a case where reactive cyclic ester carbonate is used, a film is formed on a surface of an anode, while a resistance on the surface of the anode is increased. Therefore, in this case, its discharge capacity tends to be easily decreased at the time of using and storing the secondary battery particularly in a high temperature environment.

It is desirable to provide an electrolytic solution capable of providing superior battery characteristics, a secondary battery, a battery pack, an electric vehicle, an electric power storage system, an electric power tool, and an electronic device.

According to an embodiment of the present application, there is provided an electrolytic solution comprising an allene compound having a tetravalent skeleton represented by Formula (1) described below.

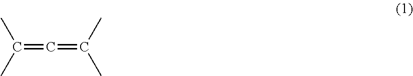

According to an embodiment of the present application, there is provided a secondary battery including: a cathode; an anode; and an electrolytic solution. The electrolytic solution includes an allene compound having a tetravalent skeleton represented by Formula (1) described below.

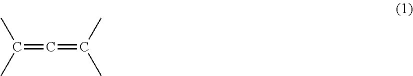

According to an embodiment of the present application, there is provided a battery pack including: a secondary battery; a control section controlling a usage state of the secondary battery; and a switch section switching the usage state of the secondary battery according to an instruction of the control section. The secondary battery includes a cathode, an anode, and an electrolytic solution. The electrolytic solution includes an allene compound having a tetravalent skeleton represented by Formula (1) described below.

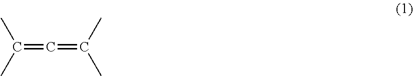

According to an embodiment of the present application, there is provided an electric vehicle including: a secondary battery; a conversion section converting electric power supplied from the secondary battery to drive power; a drive section operating according to the drive power; and a control section controlling a usage state of the secondary battery. The secondary battery includes a cathode, an anode, and an electrolytic solution. The electrolytic solution includes an allene compound having a tetravalent skeleton represented by Formula (1) described below.

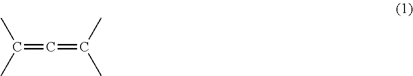

According to an embodiment of the present application, there is provided an electric power storage system including: a secondary battery; one, or two or more electric devices; and a control section controlling electric power supply from the secondary battery to the electric device. The secondary battery includes a cathode, an anode, and an electrolytic solution. The electrolytic solution includes an allene compound having a tetravalent skeleton represented by Formula (1) described below.

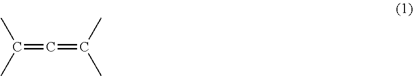

According to an embodiment of the present application, there is provided an electric power tool including: a secondary battery; and a movable section being supplied with electric power from the secondary battery. The secondary battery includes a cathode, an anode, and an electrolytic solution. The electrolytic solution includes an allene compound having a tetravalent skeleton represented by Formula (1) described below.

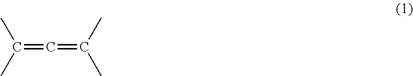

According to an embodiment of the present application, there is provided an electronic device, the electronic device being supplied with electric power from a secondary battery. The secondary battery includes a cathode, an anode, and an electrolytic solution. The electrolytic solution includes an allene compound having a tetravalent skeleton represented by Formula (1) described below.

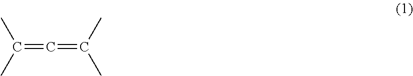

According to the electrolytic solution according to the embodiment of the present application and the secondary battery according to the embodiment of the present application, the electrolytic solution includes the allene compound having the tetravalent skeleton represented by Formula (1). Therefore, superior battery characteristics are obtainable. Further, according to the battery pack, the electric vehicle, the electric power storage system, the electric power tool, and the electronic device each using the secondary battery according to the embodiment of the present application, similar effects are obtainable.

It is to be understood that both the foregoing general description and the following detailed description are exemplary, and are intended to provide further explanation of the application as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the application.

FIG. 1 is a cross-sectional view illustrating a configuration of a secondary battery (cylindrical type) according to an embodiment of the present application.

FIG. 2 is a cross-sectional view illustrating an enlarged part of a spirally wound electrode body illustrated in FIG. 1.

FIG. 3 is a perspective view illustrating a configuration of another secondary battery (laminated film type) according to an embodiment of the present application.

FIG. 4 is a cross-sectional view taken along a line IV-IV of a spirally wound electrode body illustrated in FIG. 3.

FIG. 5 is a block diagram illustrating a configuration of an application example (battery pack) of the secondary battery.

FIG. 6 is a block diagram illustrating a configuration of an application example (electric vehicle) of the secondary battery.

FIG. 7 is a block diagram illustrating a configuration of an application example (electric power storage system) of the secondary battery.

FIG. 8 is a block diagram illustrating a configuration of an application example (electric power tool) of the secondary battery.

### DETAILED DESCRIPTION

Embodiments of the present application will be hereinafter described in detail with reference to the drawings. The description will be given in the following order.

### 1. Electrolytic Solution and Secondary Battery

1-1. Cylindrical Type

1-2. Laminated Film Type

### 2. Applications of Secondary Battery

2-1. Battery Pack

2-2. Electric Vehicle

2-3. Electric Power Storage System

2-4. Electric Power Tool

[1. Electrolytic Solution and Secondary Battery/1-1. Cylindrical Type]

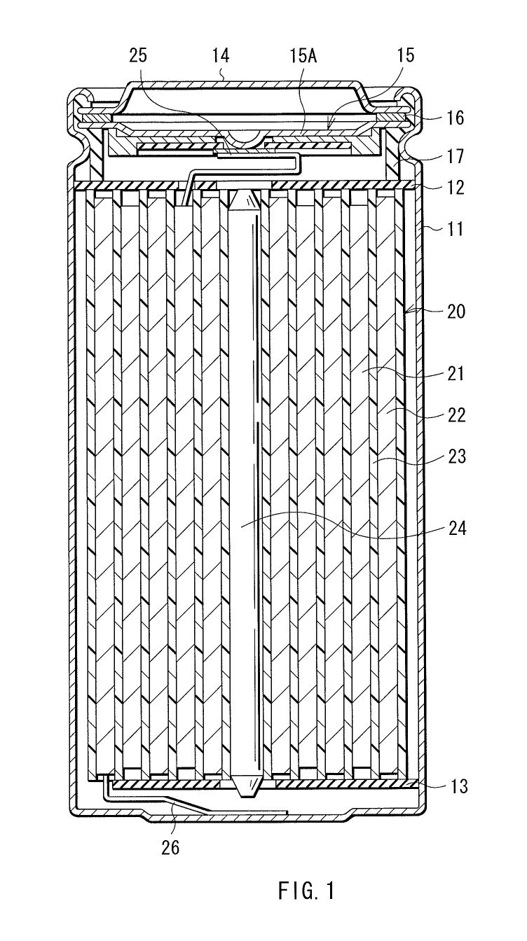

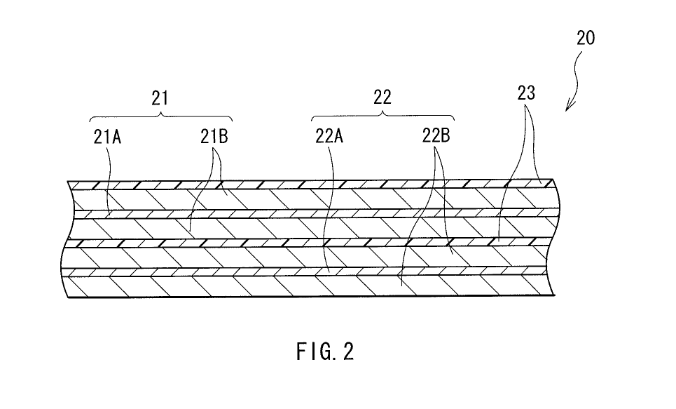

FIG. 1 and FIG. 2 illustrate cross-sectional configurations of a secondary battery using an electrolytic solution according to an embodiment of the present application. FIG. 2 illustrates enlarged part of a spirally wound electrode body 20 illustrated in FIG. 1.

[Whole Configuration of Secondary Battery]

The secondary battery is, for example, a lithium ion secondary battery in which its battery capacity is obtained by insertion and extraction of lithium ions as an electrode reactant (hereinafter simply referred to as “secondary battery”).

The secondary battery herein described is, what we call a cylindrical type secondary battery. The secondary battery contains the spirally wound electrode body 20 and a pair of insulating plates 12 and 13 inside a battery can 11 in the shape of a substantially hollow cylinder. In the spirally wound electrode body 20, for example, a cathode 21 and an anode 22 are layered with a separator 23 in between and are spirally wound.

The battery can 11 has a hollow structure in which one end of the battery can 11 is closed and the other end of the battery can 11 is opened. The battery can 11 is made of, for example, Fe, Al, an alloy thereof, or the like. The surface of the battery can 11 may be plated with Ni and/or the like. The pair of insulating plates 12 and 13 is arranged to sandwich the spirally wound electrode body 20 in between, and to extend perpendicularly to the spirally wound periphery surface.

At the open end of the battery can 11, a battery cover 14, a safety valve mechanism 15, and a PTC (Positive Temperature Coefficient) device 16 are attached by being swaged with a gasket 17. Thereby, the battery can 11 is hermetically sealed. The battery cover 14 is made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. In the PTC device 16, as temperature rises, its resistance is increased accordingly. The gasket 17 is made of, for example, an insulating material. The surface of the gasket 17 may be coated with asphalt.

In the center of the spirally wound electrode body 20, a center pin 24 may be inserted. For example, a cathode lead 25 made of a conductive material such as Al is connected to the cathode 21. For example, an anode lead 26 made of a conductive material such as Ni is connected to the anode 22. The cathode lead 25 is, for example, welded to the safety valve mechanism 15, and is electrically connected to the battery cover 14. The anode lead 26 is, for example, welded to the battery can 11, and is electrically connected to the battery can 11.

[Cathode]

In the cathode 21, for example, a cathode active material layer 21B is provided on a single surface or both surfaces of a cathode current collector 21A. The cathode current collector 21A is made of, for example, a conductive material such as Al, Ni, and stainless steel.

The cathode active material layer 21B contains, as cathode active materials, one, or two or more of cathode materials capable of inserting and extracting lithium ions. As needed, the cathode active material layer 21B may contain other material such as a cathode binder and a cathode electric conductor.

The cathode material is preferably a lithium-containing compound, since thereby high energy density is obtained. Examples of the lithium-containing compound include a composite oxide containing Li and a transition metal element as constituent elements and a phosphate compound containing Li and a transition metal element as constituent elements. Specially, it is preferable that the transition metal element be one, or two or more of Co, Ni, Mn, and Fe, since thereby a higher voltage is obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of the composite oxide containing Li and a transition metal element include LiₓCoO₂, LiₓNiO₂, and a lithium-nickel-based composite oxide represented by Formula (10). Examples of the phosphate compound containing Li and a transition metal element include LiFePO₄ and LiFe₁₋ᵤMnᵤPO₄ (u<1), since thereby a high battery capacity is obtained and superior cycle characteristics are obtained. As a cathode material, a material other than the foregoing materials may be used.

LiNi_{1-z}M_{z}O₂ (10)

In the Formula (10), M is one or more of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb. z is in the range of 0.005<z<0.5.

In addition, the cathode material may be, for example, an oxide, a disulfide, a chalcogenide, a conductive polymer, or the like. Examples of the oxide include titanium oxide, vanadium oxide, and manganese dioxide. Examples of the disulfide include titanium disulfide and molybdenum sulfide. Examples of the chalcogenide include niobium selenide. Examples of the conductive polymer include sulfur, polyaniline, and polythiophene.

Examples of the cathode binder include one, or two or more of synthetic rubbers, polymer materials, and the like. Examples of the synthetic rubber include styrene butadiene-based rubber, fluorine-based rubber, and ethylene propylene diene. Examples of the polymer material include polyvinylidene fluoride and polyimide.

Examples of the cathode electric conductor include one, or two more of carbon materials and the like. Examples of the carbon materials include graphite, carbon black, acetylene black, and Ketjen black. The cathode electric conductor may be a metal material, a conductive polymer, or the like as long as the material has electric conductivity.

[Anode]

In the anode 22, for example, an anode active material layer 22B is provided on a single surface or both surfaces of an anode current collector 22A.

The anode current collector 22A is made of, for example, a conductive material such as Cu, Ni, and stainless steel. The surface of the anode current collector 22A is preferably roughened. Thereby, due to what we call an anchor effect, adhesion characteristics of the anode active material layer 22B with respect to the anode current collector 22A are improved. In this case, it is enough that the surface of the anode current collector 22A in the region opposed to the anode active material layer 22B is roughened at minimum. Examples of roughening methods include a method of forming fine particles by electrolytic treatment. The electrolytic treatment is a method of providing concavity and convexity by forming fine particles on the surface of the anode current collector 22A by an electrolytic method in an electrolytic bath. A copper foil formed by an electrolytic method is generally called “electrolytic copper foil.”

The anode active material layer 22B contains one, or two or more of anode materials capable of inserting and extracting lithium ions as anode active materials, and may also contain other material such as an anode binder and an anode electric conductor as needed. Details of the anode binder and the anode electric conductor are, for example, respectively similar to those of the cathode binder and the cathode electric conductor. In the anode active material layer 22B, a chargeable capacity of the anode material is preferably larger than a discharge capacity of the cathode 21 in order to prevent unintentional precipitation of Li metal at the time of charge and discharge, for example.

Examples of the anode material include a carbon material. In the carbon material, its crystal structure change at the time of insertion and extraction of lithium ions is extremely small. Therefore, the carbon material provides high energy density and superior cycle characteristics. Further, the carbon material functions as an anode electric conductor as well. Examples of the carbon material include graphitizable carbon, non-graphitizable carbon in which the spacing of (002) plane is equal to or greater than 0.37 nm, and graphite in which the spacing of (002) plane is equal to or smaller than 0.34 nm. More specifically, examples of the carbon material include pyrolytic carbons, cokes, glassy carbon fiber, an organic polymer compound fired body, activated carbon, and carbon blacks. Of the foregoing, examples of the cokes include pitch coke, needle coke, and petroleum coke. The organic polymer compound fired body is obtained by firing (carbonizing) a polymer compound such as a phenol resin and a furan resin at appropriate temperature. In addition, the carbon material may be a low crystalline carbon or amorphous carbon heat-treated at temperature equal to or lower than about 1000 deg C. The shape of the carbon material may be any of a fibrous shape, a spherical shape, a granular shape, and a scale-like shape.

Further, the anode material may be, for example, a material (metal-based material) containing one, or two or more of metal elements and metalloid elements as constituent elements, since high energy density is thereby obtained. Such a metal-based material may be a simple substance, an alloy, or a compound, may be two or more thereof, or may have one or more phases thereof in part or all thereof “Alloy” includes a material containing one or more metal elements and one or more metalloid elements, in addition to a material formed of two or more metal elements. Further, the alloy may contain a nonmetallic element. Examples of the structure thereof include a solid solution, a eutectic crystal (eutectic mixture), an intermetallic compound, and a structure in which two or more thereof coexist.

The foregoing metal element and the foregoing metalloid element may be, for example, a metal element or a metalloid element capable of forming an alloy with Li. Specific examples thereof include one, or two or more of Mg, B, Al, Ga, In, Si, Ge, Sn, Pb, Bi, Cd, Ag, Zn, Hf, Zr, Y, Pd, and Pt. Specially, Si or Sn or both are preferably used. Si and Sn have a high ability of inserting and extracting lithium ions, and therefore provide high energy density.

A material containing Si or Sn or both may be, for example, a simple substance, an alloy, or a compound of Si or Sn; two or more thereof; or a material having one, or two or more phases thereof in part or all thereof. The simple substance merely refers to a general simple substance (a small amount of impurity may be therein contained), and does not necessarily refer to a purity 100% simple substance.

Examples of the alloys of Si include a material containing one, or two or more of the elements, as constituent elements other than Si, that are Sn, Ni, Cu, Fe, Co, Mn, Zn, In, Ag, Ti, Ge, Bi, Sb, and Cr. Examples of the compounds of Si include a material containing C or O as a constituent element other than Si. For example, the compounds of Si may contain one, or two or more of the elements described for the alloys of Si as constituent elements other than Si.

Examples of the alloys and the compounds of Si include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. v in SiOᵥ may be in the range of 0.2<v<1.4.

Examples of the alloys of Sn include a material containing one, or two more of the elements, as constituent elements other than Sn, that are Si, Ni, Cu, Fe, Co, Mn, Zn, In, Ag, Ti, Ge, Bi, Sb and Cr. Examples of the compounds of Sn include a material containing C or O as a constituent element. The compounds of Sn may contain one, or two or more of the elements described for the alloys of Sn as constituent elements other than Sn. Examples of the alloys and the compounds of Sn include SnO_{w} (0<w≦2), SnSiO₃, LiSnO, and Mg₂Sn.

Further, as a material containing Sn, for example, a material containing a second constituent element and a third constituent element in addition to Sn as a first constituent element is preferable. Examples of the second constituent element include one, or two or more of Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element include one, or two or more of B, C, Al, and P. In the case where the second constituent element and the third constituent element are contained, a high battery capacity, superior cycle characteristics, and the like are obtained.

Specially, a material containing Sn, Co, and C (SnCoC-containing material) is preferable. The composition of the SnCoC-containing material is, for example, as follows. That is, the C content is from 9.9 wt % to 29.7 wt % both inclusive, and the ratio of Sn and Co contents (Co/(Sn+Co)) is from 20 wt % to 70 wt % both inclusive, since high energy density is obtained in such a composition range.

It is preferable that the SnCoC-containing material have a phase containing Sn, Co, and C. Such a phase is preferably low-crystalline or amorphous. The phase is a reaction phase capable of reacting with Li. Due to existence of the reaction phase, superior characteristics are obtained. The half bandwidth of the diffraction peak obtained by X-ray diffraction of the phase is preferably equal to or greater than 1.0 deg based on diffraction angle of 2θ in the case where CuKα ray is used as a specific X ray, and the insertion rate is 1 deg/min. Thereby, lithium ions are more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with Li is allowed to be easily determined by comparison between X-ray diffraction charts before and after electrochemical reaction with Li. For example, if the position of the diffraction peak after electrochemical reaction with Li is changed from the position of the diffraction peak before the electrochemical reaction with Li, the obtained diffraction peak corresponds to the reaction phase capable of reacting with Li. In this case, for example, the diffraction peak of the low crystalline reaction phase or the amorphous reaction phase is seen in the range of 2θ=from 20 to 50 deg both inclusive. Such a reaction phase has, for example, the foregoing respective constituent elements, and the low crystalline or amorphous structure thereof possibly results from existence of C mainly.

In the SnCoC-containing material, part or all of C as a constituent element are preferably bonded with a metal element or a metalloid element as other constituent element, since thereby cohesion or crystallization of Sn or the like is suppressed. The bonding state of elements is allowed to be checked by, for example, X-ray photoelectron spectroscopy (XPS). In a commercially available device, for example, as a soft X ray, Al-Kα ray, Mg-Kα ray, or the like is used. In the case where part or all of C are bonded with a metal element, a metalloid element, or the like, the peak of a synthetic wave of 1s orbit of C(C1s) is shown in a region lower than 284.5 eV. In the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of C in the SnCoC-containing material. Therefore, for example, analysis is made by using commercially available software to isolate both peaks from each other. In the waveform analysis, the position of the main peak existing on the lowest bound energy side is the energy standard (284.8 eV).

It is to be noted that the SnCoC-containing material may further contain other constituent element as needed. Examples of other constituent elements include one, or two or more of Si, Fe, Ni, Cr, In, Nb, Ge, Ti, Mo, Al, P, Ga, and Bi.

In addition to the SnCoC-containing material, a material containing Sn, Co, Fe, and C (SnCoFeC-containing material) is also preferable. The composition of the SnCoFeC-containing material may be arbitrarily set. For example, the composition in which the Fe content is set small is as follows. That is, the C content is from 9.9 wt % to 29.7 wt % both inclusive, the Fe content is from 0.3 wt % to 5.9 wt % both inclusive, and the ratio of contents of Sn and Co (Co/(Sn+Co)) is from 30 wt % to 70 wt % both inclusive. Further, for example, the composition in which the Fe content is set large is as follows. That is, the C content is from 11.9 wt % to 29.7 wt % both inclusive, the ratio of contents of Sn, Co, and Fe ((Co+Fe)/(Sn+Co+Fe)) is from 26.4 wt % to 48.5 wt % both inclusive, and the ratio of contents of Co and Fe (Co/(Co+Fe)) is from 9.9 wt % to 79.5 wt % both inclusive. In such a composition range, high energy density is obtained. Physical properties (half bandwidth and the like) of the SnCoFeC-containing material are similar to those of the foregoing SnCoC-containing material.

In addition, the anode material may be, for example, a metal oxide, a polymer compound, or the like. Examples of the metal oxide include iron oxide, ruthenium oxide, and molybdenum oxide. Examples of the polymer compound include polyacetylene, polyaniline, and polypyrrole.

The anode active material layer 22B is formed by, for example, a coating method, a vapor-phase deposition method, a liquid-phase deposition method, a spraying method, a firing method (sintering method), or a combination of two or more of these methods. The coating method is a method in which, for example, after a particulate anode active material is mixed with a binder and/or the like, the mixture is dispersed in a solvent such as an organic solvent, and the anode current collector is coated with the resultant. Examples of the vapor-phase deposition method include a physical deposition method and a chemical deposition method. Specifically, examples thereof include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method include an electrolytic plating method and an electroless plating method. The spraying method is a method in which an anode active material is sprayed in a fused state or a semi-fused state. The firing method is, for example, a method in which after the anode current collector is coated by a procedure similar to that of the coating method, heat treatment is performed at temperature higher than the melting point of the binder and/or the like. Examples of the firing method include a known technique such as an atmosphere firing method, a reactive firing method, and a hot press firing method.

In the secondary battery, as described above, in order to prevent Li metal from being unintentionally precipitated on the anode 22 in the middle of charge, the electrochemical equivalent of the anode material capable of inserting and extracting lithium ions is larger than the electrochemical equivalent of the cathode. Further, in the case where the open circuit voltage (that is, a battery voltage) at the time of completely-charged state is equal to or greater than 4.25 V, the extraction amount of lithium ions per unit weight is larger than that in the case that the open circuit voltage is 4.20 V even if the same cathode active material is used. Therefore, amounts of the cathode active material and the anode active material are adjusted accordingly. Thereby, high energy density is obtainable.

[Separator]

The separator 23 separates the cathode 21 from the anode 22, and passes lithium ions while preventing current short circuit resulting from contact of both electrodes. The separator 23 is formed of, for example, a porous film made of a synthetic resin or ceramics. The separator 23 may be a laminated film in which two or more types of porous films are layered. Examples of the synthetic resin include polytetrafluoroethylene, polypropylene, and polyethylene.

In particular, the separator 23 may include, for example, a base material layer formed of the foregoing porous film and a polymer compound layer provided on one surface or both surfaces of the base material layer. Thereby, adhesion characteristics of the separator 23 with respect to the cathode 21 and the anode 22 are improved, and thus skewness of the spirally wound electrode body 20 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance of the secondary battery is less likely to be increased, and battery swollenness is suppressed.

The polymer compound layer contains, for example, a polymer material such as polyvinylidene fluoride, since such a polymer material has a superior physical strength and is electrochemically stable. However, the polymer material may be a material other than polyvinylidene fluoride. The polymer compound layer is formed as follows, for example. That is, after a solution in which the polymer material is dissolved is prepared, the surface of the base material layer is coated with the solution or the base material layer is soaked in the solution, and the resultant is subsequently dried.

[Electrolytic Solution]

The separator 23 is impregnated with an electrolytic solution as a liquid electrolyte. The electrolytic solution contains one, or two or more of allene compounds having a tetravalent skeleton represented by Formula (1) described below together with a solvent and an electrolyte salt. However, the electrolytic solution may contain other material such as an additive as needed.

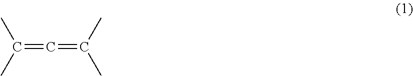

The allene compound has an allene skeleton, that is, adjacent two carbon-carbon double bonds (C═C═C). In the allene skeleton, both two carbon atoms (C) located on both ends have two bonding hands (dangling bonds). Therefore, the allene skeleton is tetravalent as a whole.

The electrolytic solution contains the allene compound for the following reason. That is, since thereby an extremely rigid film is formed on the surface of the anode 22 at the time of the initial charge mainly, a decomposition reaction of the electrolytic solution due to reactivity of the anode 22 is significantly suppressed. Thereby, a discharge capacity at the time of using and storing the secondary battery in a high temperature environment is less likely to be decreased.

More specifically, in the case where the secondary battery including the electrolytic solution is charged and discharged, a solid electrolyte interface (SEI) film as a protective film is formed on the surface of the anode 22 by a reactant, a decomposed matter, or the like of the solvent, the electrolyte salt, and the like at the time of the initial charge mainly. Due to the SEI film, the anode 22 becomes stabilized electrochemically. Therefore, a decomposition reaction of the electrolytic solution due to reactivity of the anode 22 is suppressed. Further, since the SEI film has ion conductivity, even if the SEI film is formed on the surface of the anode 22, insertion and extraction of lithium ions are secured.

In the case where the highly reactive allene compound having an allene skeleton exists in the electrolytic solution, the allene compound is reacted (for example, cross-linking reaction or the like) at the time of forming the SEI film, and therefore a polymer compound growing in the three-dimensional direction is formed. Such reaction of the allene compound includes not only a reaction between the allene compounds but also a reaction between the allene compound and other material such as a solvent and an electrolyte salt. Thereby, the SEI film containing the polymer compound originated in the allene compound is formed. Accordingly, the intensity of the SEI film is extraordinarily improved compared to in a case where the allene compound is not contained in the electrolytic solution. In this case, as the number of reaction points (for example, cross-linking points) is larger, the melting point of the polymer compound is higher. Accordingly, solubility of the polymer compound is lowered, and therefore the SEI film becomes stable even in a high temperature environment. Therefore, the SEI film is not dissolved and retained even in a high temperature environment, and accordingly lowering of a discharge capacity caused by a decomposition of the electrolytic solution is suppressed.

Types of four groups (bond groups) bonded with the carbon atoms on both ends of the allene compound are not particularly limited as long as the groups are monovalent groups. As long as the allene compound has an allene skeleton, the allene compound becomes highly reactive without depending on the bond group type, and therefore the foregoing advantage resulting from the reactivity of the allene compound (formation of the polymer compound) is obtainable. The four bond groups may be the same type of groups, or may be groups different from each other. Alternately, two or more of the four bond groups may be the same type of groups.

The whole configuration of the allene compound is not particularly limited as long as the foregoing allene skeleton is therein included. For example, the whole configuration of the allene compound is represented by Formula (2) described below, since such a configuration is easily synthesized, and thereby the foregoing advantage originated in the allene compound is easily obtained.

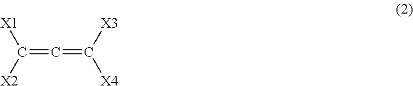

In the formula, each of X1 to X4 is one of a hydrogen group (—H), a halogen group (—F, —Cl, —Br, or —I), an alkyl group, a halogenated alkyl group, an aryl group, a halogenated aryl group, a hydroxyl group (—OH), an alkoxy group (—OR1), an aldehyde group (—CHO), a carboxyl group (—COOH), an acid halide group (—COF, —COCl, —COBr, or —COI), an amino group (—NR2₂), a thiol group (—SH), a thioalkoxy group (—SR1), a sulfonate group (—SO₃H), a cyano group (—CN), an isocyanate group (—NCO), a thioisocyanate group (—NCS), an ester carbonate group (—OCOOR1), a carboxylic ester group (—COOR1), a carboxylic anhydride group (—COOCOR1), an amido group (—NRCOR1), a sulfonic ester group (—SO₃R1), a sulfonic anhydride group (—SO₂OSO₂R1), a sulfuric ester group (—OSO₂OR1), a carbamic ester group (—NHCOOR1), a silyl ether group (—OSiR1₃), a borate ester group (—B(OR1)₂), a phosphoric ester group (—OP(═O)(OR1)₂), a phosphorous ester group (—OP(OR1)₂), a titanate ester group (—OTi(OR1)₃), and an aluminate ester group (—OAl(OR1)₂); arbitrary two or more of the X1 to the X4 are allowed to be bonded with each other and arbitrary two or more of the plurality of R1s are allowed to be bonded with each other; the R1 is an alkyl group; and the R2 is one of a hydrogen group and an alkyl group.

In the allene compound, X1 to X4 may be the same type of group, may be groups different from each other, or two or more of X1 to X4 may be the same type of group. As described above, the foregoing advantage resulting from reactivity of the allene compound is obtained in any group combination of X1 to X4.

Arbitrary two or more of X1 to X4 may form one, or two or more rings by bonding with each other in their ends or in the middle thereof. Further, similarly, arbitrary two or more of a plurality of R1s may form one, or two or more rings by bonding with each other in their ends or in the middle thereof. As an example, in the case where both X1 and X2 are alkyl groups, the alkyl groups may be bonded with each other. Further, in the case where X1 is a phosphoric ester group (—OP(═O)(OR1)₂), R1s out of such OR1s may be bonded with each other to form a ring.

With regard to X1 to X4, “halogenated alkyl group” is obtained by substituting one or more of “H”s out of an alkyl group by a halogen, and “halogenated aryl group” is obtained by substituting one or more of “H”s out of an aryl group by a halogen. For example, halogen type is similar to that of the halogen groups.

In the case where each of X1 to X4 is an alkyl group or a halogenated alkyl group, the carbon number of such alkyl group or the like is not particularly limited. Specific examples of the alkyl group include a methyl group, an ethyl group, a propyl group, a butyl group, and a hexyl group. Specific examples of the halogenated alkyl group include a fluoromethyl group, a difluoromethyl group, a trifluoromethyl group, a pentafluoroethyl group, a 2,2,2-trifluoroethyl group, and a heptafluoropropyl group.

Specifically, in the case where each of X1 to X4 is a hydrogen group or an alkyl group, one or more of X1 to X4 are preferably an alkyl group, and the carbon number of such an alkyl group is preferably equal to or greater than 4. One reason for this is that, in this case, the boiling point of the allene compound is increased, and accordingly the allene compound becomes liquid at ambient temperature (23 deg C.). Thereby, in the case where the electrolytic solution contains a chain ester carbonate or a cyclic ester carbonate described later as a solvent, the boiling point of the allene compound becomes closer to the boiling point of the solvent. Therefore, at the time of preparing the electrolytic solution, handling of the allene compound becomes easy similarly to handling of the solvent. In addition, in the electrolytic solution containing the solvent and the allene compound, the allene compound is less likely to be gasified singly.

Further, the carbon number of such an alkyl group is preferably equal to or smaller than 10. One reason for this is that, in this case, solubility and compatibility of the allene compound with respect to the solvent such as an ester carbonate described later are secured.

Specific examples of the aryl group include a phenyl group, a tolyl group, and a naphtyl group. Further, specific examples of the halogenated aryl group include a 2-fluoro-pheny group.

The carbon numbers of R1 and R2 as alkyl groups are not particularly limited. However, if the carbon numbers thereof are excessively high, solubility, compatibility, and the like of the allene compound are possibly lowered. Therefore, it is preferable that the carbon numbers thereof be not excessively high. Specifically, the carbon numbers thereof are preferably equal to or smaller than 10.

Specially, each of X1 to X3 is preferably a hydrogen group, a halogen group, an alkyl group, a halogenated alkyl group, an aryl group, or a halogenated aryl group. Further, X4 is preferably a hydroxyl group, an alkoxy group, an aldehyde group, a carboxyl group, an acid halide group, an amino group, a thiol group, a thioalkoxy group, a sulfonate group, a cyano group, an isocyanate group, a thioisocyanate group, an ester carbonate group, a carboxylic ester group, a carboxylic anhydride group, an amide group, a sulfonic ester group, a sulfonic anhydride group, a sulfuric ester group, a carbamic ester group, a silyl ether group, a borate ester group, a phosphoric ester group, a phosphorous ester group, a titanate ester group, or an aluminate ester group. Thereby, reactivity of the allene compound is improved, and therefore the allene compound easily forms the polymer compound at the time of the initial charge.

Specially, X4 is preferably an alkoxy group, an acid halide group, a cyano group, an isocyanate group, an ester carbonate group, a carboxylic anhydride group, a sulfonic ester group, a sulfonic anhydride group, a silyl ether group, or a borate ester group. One reason for this is that, in this case, reactivity of the allene compound is more improved. Further, another reason is that, in the case where the allene compound has a functional group similar to all or partial chemical structure of the solvent as X4, the ion conductivity of the SEI film is retained, and the resistance of the SEI film is lowered. “The allene compound has a functional group similar to all or partial chemical structure of the solvent as X4” refers to, for example, a case in which the allene compound has an ester carbonate group as X4 in the case that the electrolytic solution contains a chain or cyclic ester carbonate described later as a solvent.

Specific examples of the allene compound are represented by Formula (I-1) to Formula (I-37). However, examples of the allene compound are not limited to the allene compounds herein specifically listed.

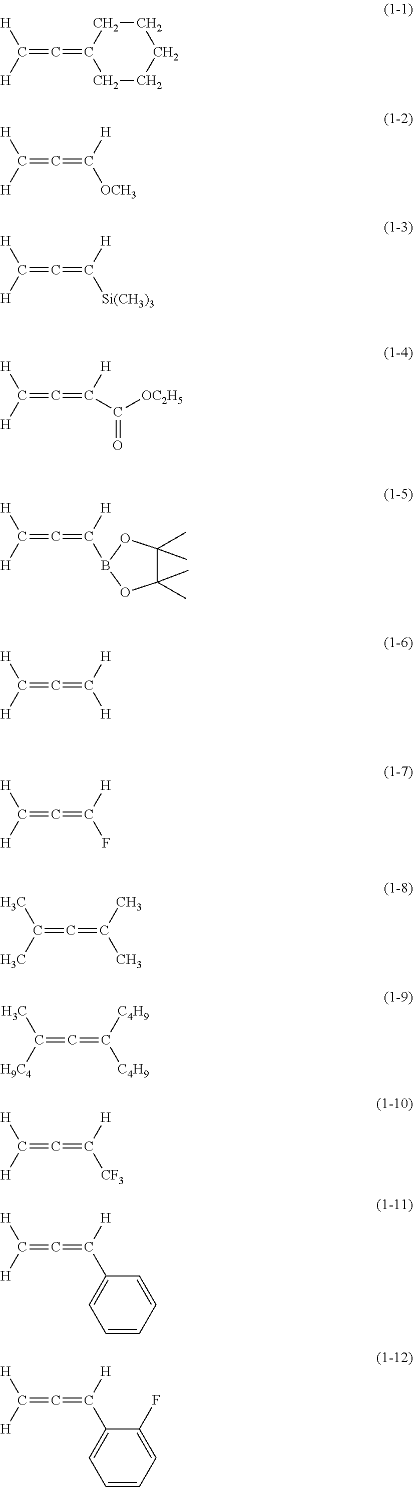

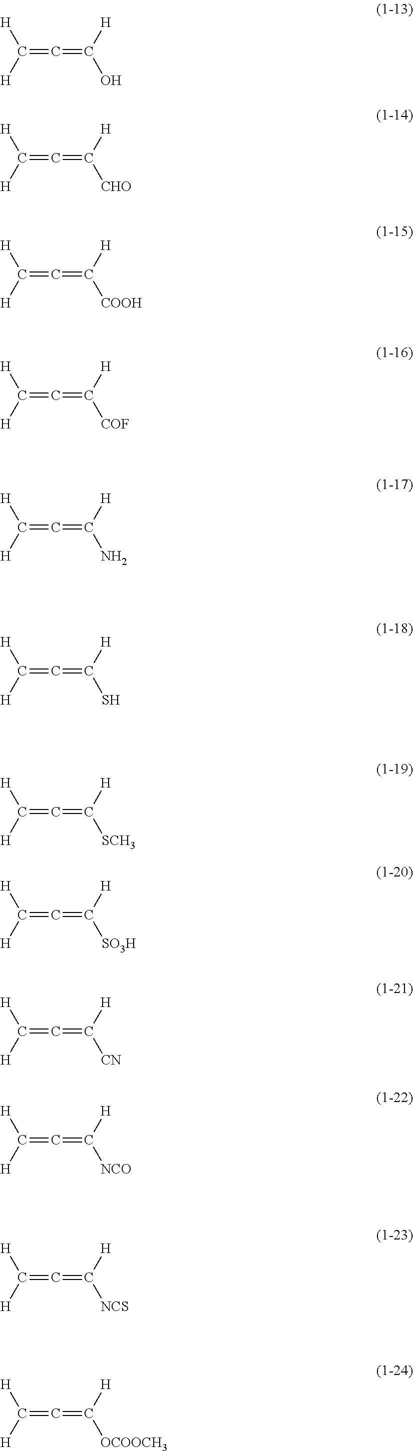

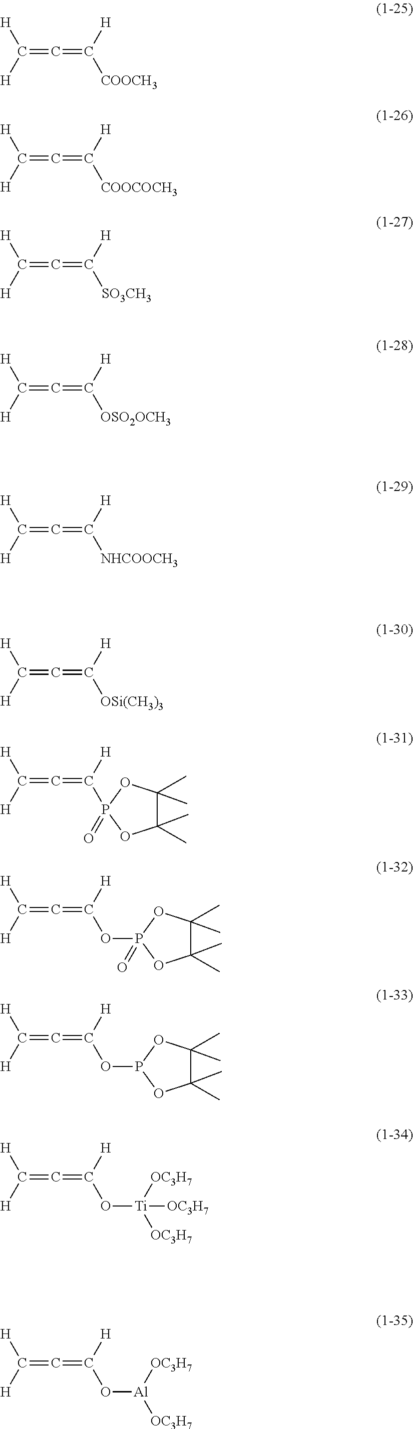

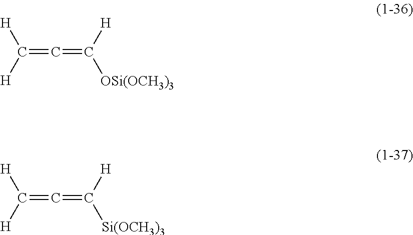

Though the content of the allene compound in the electrolytic solution is not particularly limited, the content thereof is preferably from 0.05 wt % to 2 wt % both inclusive, and is more preferably from 0.3 wt % to 1 wt % both inclusive since higher effects are thereby obtained.

The solvent contains, for example, one, or two or more of nonaqueous solvents such as an organic solvent. Examples of the nonaqueous solvents include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. By using such a nonaqueous solvent, a superior battery capacity, superior cycle characteristics, superior conservation characteristics, and the like are obtained.

Specially, one or more of ethylene carbonate, propylene carbonate, dimethyl carbonate, diethyl carbonate, and ethyl methyl carbonate are preferable, since thereby more superior characteristics are obtained. In this case, a combination of a high viscosity (high dielectric constant) solvent (for example, specific dielectric constant ∈≧30) such as ethylene carbonate and a propylene carbonate and a low viscosity solvent (for example, viscosity≦1 mPa·s) such as dimethyl carbonate, ethylmethyl carbonate, and diethyl carbonate is more preferable. Thereby, dissociation property of the electrolyte salt and ion mobility are improved.

In particular, the solvent preferably contains a cyclic ester carbonate having one, or two or more unsaturated carbon bonds (unsaturated carbon bond cyclic ester carbonate). One reason for this is that, in this case, since a stable protective film is formed on the surface of the anode 22 at the time of charge and discharge, a decomposition reaction of the electrolytic solution is suppressed. Examples of the unsaturated carbon bond cyclic ester carbonate include vinylene carbonate (1,3-dioxole-2-one), methylvinylene carbonate (4-methyl-1,3-dioxole-2-one), ethylvinylene carbonate (4-ethyl-1,3-dioxole-2-one), 4,5-dimethyl-1,3-dioxole-2-one, 4,5-diethyl-1,3-dioxole-2-one, 4-fluoro-1,3-dioxole-2-one, and 4-trifluoromethyl-1,3-dioxole-2-one. The content of the unsaturated carbon bond cyclic ester carbonate in the solvent is, for example, from 0.01 wt % to 10 wt % both inclusive, since thereby a decomposition reaction of the electrolytic solution is suppressed while a battery capacity is not excessively lowered.

Further, the solvent preferably contains a chain ester carbonate having one, or two or more halogens (halogenated chain ester carbonate), or a cyclic ester carbonate having one, or two or more halogens (halogenated cyclic ester carbonate), or both. One reason for this is that, since a stable protective film is thereby formed on the surface of the anode 22 at the time of charge and discharge, a decomposition reaction of the electrolytic solution is suppressed. Though halogen type is not particularly limited, specially, F, Cl, or Br is preferable, and F is more preferable, since thereby a higher effect is obtained. The number of halogens is more preferably two than one, and further may be three or more, since thereby a more rigid and more stable protective film is formed, and therefore a decomposition reaction of the electrolytic solution is more suppressed.

Examples of the halogenated chain ester carbonate include fluoromethyl methyl carbonate, bis(fluoromethyl)carbonate, and difluoromethyl methyl carbonate. Examples of the halogenated cyclic ester carbonate include 4-fluoro-1,3-dioxolane-2-one, 4-chloro-1,3-dioxolane-2-one, 4,5-difluoro-1,3-dioxolane-2-one, tetrafluoro-1,3-dioxolane-2-one, 4-fluoro-5-chloro-1,3-dioxolane-2-one, 4,5-dichloro-1,3-dioxolane-2-one, tetrachloro-1,3-dioxolane-2-one, 4,5-bistrifluoromethyl-1,3-dioxolane-2-one, 4-trifluoromethyl-1,3-dioxolane-2-one, 4,5-difluoro-4,5-dimethyl-1,3-dioxolane-2-one, 4-methyl-5,5-difluoro-1,3-dioxolane-2-one, 4-ethyl-5,5-difluoro-1,3-dioxolane-2-one, 4-trifluoromethyl-5-fluoro-1,3-dioxolane-2-one, 4-trifluoromethyl-5-methyl-1,3-dioxolane-2-one, 4-fluoro-4,5-dimethyl-1,3-dioxolane-2-one, 4,4-difluoro-5-(1,1-difluoroethyl)-1,3-dioxolane-2-one, 4,5-dichloro-4,5-dimethyl-1,3-dioxolane-2-one, 4-ethyl-5-fluoro-1,3-dioxolane-2-one, 4-ethyl-4,5-difluoro-1,3-dioxolane-2-one, 4-ethyl-4,5,5-trifluoro-1,3-dioxolane-2-one, and 4-fluoro-4-methyl-1,3-dioxolane-2-one. The contents of the halogenated chain ester carbonate and the halogenated cyclic ester carbonate in the nonaqueous solvent are, for example, from 0.01 wt % to 50 wt % both inclusive, since thereby a decomposition reaction of the electrolytic solution is suppressed without excessively lowering a battery capacity.

Further, the solvent may contain sultone (cyclic sulfonic ester), since thereby chemical stability of the electrolytic solution is improved. Examples of the sultone include propane sultone and propene sultone. Though the content of the sultone in the solvent is not particularly limited, for example, the content thereof is from 0.5 wt % to 5 wt % both inclusive, since thereby a decomposition reaction of the electrolytic solution is suppressed without excessively lowering a battery capacity.

Further, the solvent may contain an acid anhydride, since chemical stability of the electrolytic solution is thereby further improved. Examples of the acid anhydride include a dicarboxylic anhydride, a disulfonic anhydride, and a carboxylic sulfonic anhydride. Examples of the dicarboxylic anhydride include succinic anhydride, glutaric anhydride, and maleic anhydride. Examples of the disulfonic anhydride include anhydrous ethane disulfonic acid and anhydrous propane disulfonic acid. Examples of the carboxylic sulfonic anhydride include anhydrous sulfobenzoic acid, anhydrous sulfopropionate, and anhydrous sulfobutyrate. Though the content of the acid anhydride in the solvent is not particularly limited, for example, the content thereof is from 0.5 wt % to 5 wt % both inclusive since thereby a decomposition reaction of the electrolytic solution is suppressed without excessively lowering a battery capacity.

[Electrolyte Salt]

The electrolyte salt contains, for example, one, or two or more of lithium salts described below. However, the electrolyte salt may be a salt other than the lithium salt (for example, a light metal salt other than the lithium salt).

Examples of the lithium salt include compounds such as LiPF₆, LiBF₄, LiClO₄, LiAsF₆, LiB(C₆H₅)₄, LiCH₃SO₃, LiCF₃SO₃, LiAlCl₄, Li₂SiF₆, LiCl, and LiBr. Thereby, a superior battery capacity, superior cycle characteristics, superior conservation characteristics, and the like are obtained.

Specially, one or more of LiPF₆, LiBF₄, LiClO₄, and LiAsF₆ are preferable, and LiPF₆ is more preferable, since thereby the internal resistance is lowered, and higher effects are obtained.

The content of the electrolyte salt is preferably from 0.3 mol/kg to 3.0 mol/kg both inclusive with respect to the solvent, since thereby high ion conductivity is obtained.

[Operation of Secondary Battery]

In the secondary battery, for example, at the time of charge, lithium ions extracted from the cathode 21 are inserted in the anode 22 through the electrolytic solution. Further, at the time of discharge, lithium ions extracted from the anode 22 are inserted in the cathode 21 through the electrolytic solution.

[Method of Manufacturing Secondary Battery]

The secondary battery is manufactured, for example, by the following procedure.

First, the cathode 21 is formed. A cathode active material is mixed with a cathode binder, a cathode electric conductor, and/or the like as needed to prepare a cathode mixture. Subsequently, the cathode mixture is dispersed in an organic solvent or the like to obtain a paste cathode mixture slurry. Subsequently, both surfaces of the cathode current collector 21A are coated with the cathode mixture slurry, which is dried to form the cathode active material layer 21B. Subsequently, the cathode active material layer 21B is compression-molded by using a roll pressing machine and/or the like while being heated as needed. In this case, compression-molding may be repeated several times.

Further, the anode 22 is formed by a procedure similar to that of the cathode 21 described above. An anode active material is mixed with an anode binder, an anode electric conductor, and/or the like as needed to prepare an anode mixture, which is subsequently dispersed in an organic solvent or the like to form a paste anode mixture slurry. Subsequently, both surfaces of the anode current collector 22A are coated with the anode mixture slurry, which is dried to form the anode active material layer 22B. After that, the anode active material layer 22B is compression-molded as needed.

Further, after an electrolyte salt is dispersed in a solvent, an allene compound is added thereto to prepare an electrolytic solution.

Finally, the secondary battery is assembled by using the cathode 21 and the anode 22. First, the cathode lead 25 is attached to the cathode current collector 21A by using a welding method and/or the like, and the anode lead 26 is attached to the anode current collector 22A by using a welding method and/or the like. Subsequently, the cathode 21 and the anode 22 are layered with the separator 23 in between and are spirally wound, and thereby the spirally wound electrode body 20 is formed. After that, the center pin 24 is inserted in the center of the spirally wound electrode body 20. Subsequently, the spirally wound electrode body 20 is sandwiched between the pair of insulating plates 12 and 13, and is contained in the battery can 11. In this case, the end tip of the cathode lead 25 is attached to the safety valve mechanism 15 by using a welding method and/or the like, and the end tip of the anode lead 26 is attached to the battery can 11 by using a welding method and/or the like. Subsequently, the electrolytic solution is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

[Function and Effect of Secondary Battery]

According to the cylindrical type secondary battery, the electrolytic solution contains the allene compound having the tetravalent skeleton represented by Formula (1). In this case, as described above, the rigid SEI film containing the polymer compound originated in the highly reactive allene compound is formed on the surface of the anode 22. Therefore, lowering of a discharge capacity is suppressed even at the time of using and storing the secondary battery in a high temperature environment. Accordingly, superior battery characteristics are obtained.

In particular, in the case where the electrolytic solution contains the allene compound represented by Formula (2), or the content of the allene compound in the electrolytic solution is from 0.05 wt % to 2 wt % both inclusive or is more preferably from 0.3 wt % to 1 wt % both inclusive, higher effects are obtained. In this case, in the case where X4 in Formula (2) is an acid halide group, a cyano group, an isocyanate group, an ester carbonate group, a carboxylic anhydride group, a sulfonic ester group, a sulfonic anhydride group, a silyl ether group, or a borate ester group, higher effects are obtained.

[1-2. Laminated Film Type]

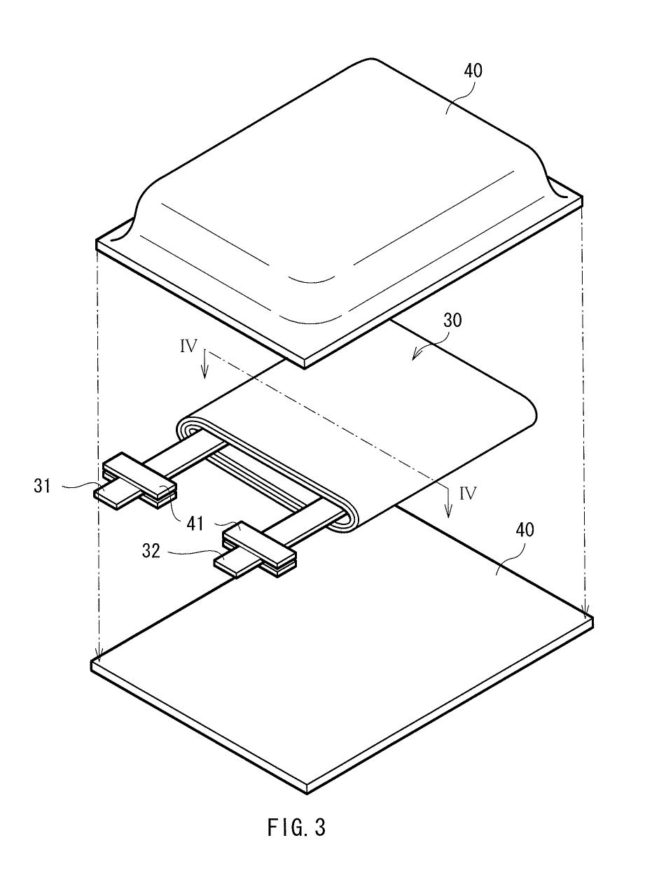

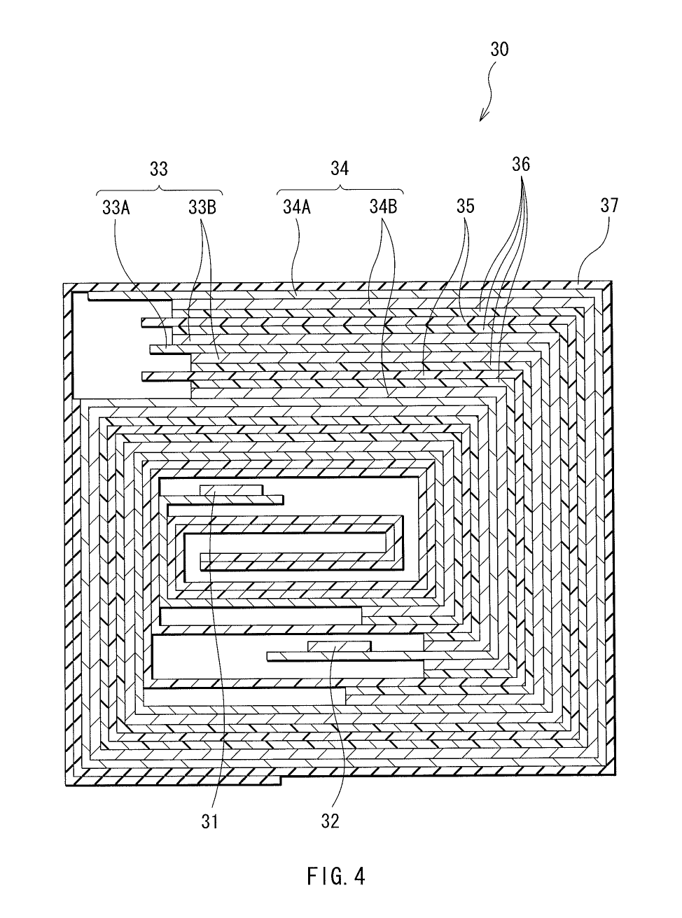

FIG. 3 illustrates an exploded perspective configuration of another secondary battery according to an embodiment of the present application. FIG. 4 illustrates an enlarged cross-section taken along a line VI-VI of a spirally wound electrode body 30 illustrated in FIG. 3. In the following description, the elements of the cylindrical type secondary battery described above will be used as needed.

[Whole Structure of Secondary Battery]

The secondary battery herein described is what we call a laminated film type lithium ion secondary battery. In the secondary battery, the spirally wound electrode body 30 is contained in a film outer package member 40. In the spirally wound electrode body 30, a cathode 33 and an anode 34 are layered with a separator 35 and an electrolyte layer 36 in between and are spirally wound. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 are, for example, led out from inside to outside of the outer package member 40 in the same direction. The cathode lead 31 is made of, for example, a conductive material such as Al, and the anode lead 32 is made of, for example, a conducive material such as Cu, Ni, and stainless steel. These materials are in the shape of, for example, a thin plate or mesh.

The outer package member 40 is a laminated film in which, for example, a fusion bonding layer, a metal layer, and a surface protective layer are layered in this order. In the laminated film, for example, the respective outer edges of the fusion bonding layers of two films are bonded with each other by fusion bonding, an adhesive, or the like so that the fusion bonding layers and the spirally wound electrode body 30 are opposed to each other. Examples of the fusion bonding layer include a film made of polyethylene, polypropylene, or the like. Examples of the metal layer include an Al foil. Examples of the surface protective layer include a film made of nylon, polyethylene terephthalate, or the like.

Specially, as the outer package member 40, an aluminum laminated film in which a polyethylene film, an aluminum foil, and a nylon film are layered in this order is preferable. However, the outer package member 40 may be made of a laminated film having other laminated structure, a polymer film such as polypropylene, or a metal film.

An adhesive film 41 to protect from outside air intrusion is inserted between the outer package member 40, and the cathode lead 31 and the anode lead 32. The adhesive film 41 is made of a material having adhesion characteristics with respect to the cathode lead 31 and the anode lead 32. Examples of such a material include a polyolefin resin such as polyethylene, polypropylene, modified polyethylene, and modified polypropylene.

In the cathode 33, for example, a cathode active material layer 33B is provided on both surfaces of a cathode current collector 33A. In the anode 34, for example, an anode active material layer 34B is provided on both surfaces of an anode current collector 34A. The configurations of the cathode current collector 33A, the cathode active material layer 33B, the anode current collector 34A, and the anode active material layer 34B are respectively similar to the configurations of the cathode current collector 21A, the cathode active material layer 21B, the anode current collector 22A, and the anode active material layer 22B. Further, the configuration of the separator 35 is similar to the configuration of the separator 23.

In the electrolyte layer 36, an electrolytic solution is held by a polymer compound. The electrolyte layer 36 may contain other material such as an additive as needed. The electrolyte layer 36 is what we call a gel electrolyte, since thereby high ion conductivity (for example, 1 mS/cm or more at room temperature) is obtained and liquid leakage of the electrolytic solution is prevented.

Examples of the polymer compound include one, or two or more of the following polymer materials. That is, examples thereof include polyacrylonitrile, polyvinylidene fluoride, polytetrafluoroethylene, polyhexafluoropropylene, polyethylene oxide, polypropylene oxide, polyphosphazene, polysiloxane, and polyvinyl fluoride. Further, examples thereof include polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. Further examples thereof include a copolymer of vinylidene fluoride and hexafluoro propylene. Specially, polyvinylidene fluoride or the copolymer of vinylidene fluoride and hexafluoro propylene is preferable, and polyvinylidene fluoride is more preferable, since such a polymer compound is electrochemically stable.

The composition of the electrolytic solution is similar to the composition of the electrolytic solution of the cylindrical type secondary battery. The electrolytic solution contains the allene compound. However, in the electrolyte layer 36 as a gel electrolyte, the solvent of the electrolytic solution represents a wide concept including not only a liquid solvent but also a material having ion conductivity capable of dissociating the electrolyte salt. Therefore, in the case where a polymer compound having ion conductivity is used, the polymer compound is also included in the solvent.

Instead of the gel electrolyte layer 36, the electrolytic solution may be used as it is. In this case, the separator 35 is impregnated with the electrolytic solution.

[Operation of Secondary Battery]

In the secondary battery, for example, at the time of charge, lithium ions extracted from the cathode 33 are inserted in the anode 34 through the electrolyte layer 36. Meanwhile, at the time of discharge, lithium ions extracted from the anode 34 are inserted in the cathode 33 through the electrolyte layer 36.

[Method of Manufacturing Secondary Battery]

The secondary battery including the gel electrolyte layer 36 is manufactured, for example, by the following three types of procedures.

In the first procedure, the cathode 33 and the anode 34 are formed by a formation procedure similar to that of the cathode 21 and the anode 22. In this case, the cathode 33 is formed by forming the cathode active material layer 33B on both surfaces of the cathode current collector 33A, and the anode 34 is formed by forming the anode active material layer 34B on both surfaces of the anode current collector 34A. Subsequently, a precursor solution containing an electrolytic solution, a polymer compound, and a solvent such as an organic solvent is prepared. After that, the cathode 33 and the anode 34 are coated with the precursor solution to form the gel electrolyte layer 36. Subsequently, the cathode lead 31 is attached to the cathode current collector 33A by a welding method and/or the like and the anode lead 32 is attached to the anode current collector 34A by a welding method and/or the like. Subsequently, the cathode 33 and the anode 34 provided with the electrolyte layer 36 are layered with the separator 35 in between and are spirally wound to form the spirally wound electrode body 30. After that, the protective tape 37 is adhered to the outermost periphery thereof. In preparing the separator 35, as needed, a coating layer containing an organic silicon compound is formed on the surface of a base material layer. Subsequently, after the spirally wound electrode body 30 is sandwiched between two pieces of film-like outer package members 40, the outer edges of the outer package members 40 are bonded by a thermal fusion bonding method and/or the like to enclose the spirally wound electrode body 30 into the outer package members 40. In this case, the adhesive films 41 are inserted between the cathode lead 31 and the anode lead 32, and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to form a spirally wound body as a precursor of the spirally wound electrode body 30. After that, the protective tape 37 is adhered to the outermost periphery thereof. Subsequently, after the spirally wound body is sandwiched between two pieces of the film-like outer package members 40, the outermost peripheries except for one side are bonded by a thermal fusion bonding method and/or the like to obtain a pouched state, and the spirally wound body is contained in the pouch-like outer package member 40. Subsequently, a composition for electrolyte containing an electrolytic solution, a monomer as a raw material for the polymer compound, a polymerization initiator, and other materials such as a polymerization inhibitor as needed is prepared, which is injected into the pouch-like outer package member 40. After that, the outer package member 40 is hermetically sealed by a thermal fusion bonding method and/or the like. Subsequently, the monomer is thermally polymerized. Thereby, a polymer compound is formed, and therefore the gel electrolyte layer 36 is formed.

In the third procedure, the spirally wound body is formed and contained in the pouch-like outer package member 40 in a manner similar to that of the foregoing second procedure, except that the separator 35 with both surfaces coated with a polymer compound is used. Examples of the polymer compound with which the separator 35 is coated include a polymer (a homopolymer, a copolymer, a multicomponent copolymer, or the like) containing vinylidene fluoride as a component. Specific examples thereof include polyvinylidene fluoride, a binary copolymer containing vinylidene fluoride and hexafluoro propylene as components, and a ternary copolymer containing vinylidene fluoride, hexafluoro propylene, and chlorotrifluoroethylene as components. In addition to the polymer containing vinylidene fluoride as a component, other one, or two or more polymer compounds may be used. Subsequently, an electrolytic solution is prepared and injected into the outer package member 40. After that, the opening of the outer package member 40 is hermetically sealed by a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly the polymer compound is gelated to form the electrolyte layer 36.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Thus, the formation step of the polymer compound is favorably controlled. Therefore, sufficient adhesion characteristics are obtained between the cathode 33, the anode 34, and the separator 35, and the electrolyte layer 36.

[Function and Effect of Secondary Battery]

According to the laminated film type secondary battery, the electrolytic solution of the electrolyte layer 36 contains the allene compound having the tetravalent skeleton represented by Formula (1). Therefore, for a reason similar to that of the cylindrical type secondary battery, superior battery characteristics are obtainable. Other functions and other effects are similar to those of the cylindrical type secondary battery.

[2. Applications of Secondary Battery]

Next, a description will be given of application examples of the foregoing secondary battery.

Applications of the secondary battery are not particularly limited as long as the secondary battery is used for a machine, a device, an instrument, an apparatus, a system (collective entity of a plurality of devices and the like), or the like that is allowed to use the secondary battery as a driving electric power source, an electric power storage source for electric power storage, or the like. In the case where the secondary battery is used as an electric power source, the secondary battery may be used as a main electric power source (electric power source used preferentially), or an auxiliary electric power source (electric power source used instead of a main electric power source or used being switched from the main electric power source). In the latter case, the main power source type is not limited to the secondary battery.

Examples of applications of the secondary battery include mobile electronic devices such as a video camcoder, a digital still camera, a mobile phone, a notebook personal computer, a cordless phone, a headphone stereo, a portable radio, a portable television, and a personal digital assistant. Further examples thereof include a mobile lifestyle electric appliance such as an electric shaver; a memory device such as a backup electric power source and a memory card; an electric power tool such as an electric drill and an electric saw; a battery pack used as an electric power source of a notebook personal computer or the like; a medical electronic device such as a pacemaker and a hearing aid; an electric vehicle such as an electric automobile (including a hybrid automobile); and an electric power storage system such as a home battery system for storing electric power for emergency or the like. It is needless to say that an application other than the foregoing applications may be adopted.

Specially, the secondary battery is effectively applicable to the battery pack, the electric vehicle, the electric power storage system, the electric power tool, the electronic device, or the like. In these applications, since superior battery characteristics are demanded, the characteristics are effectively improved by using the secondary battery according to the embodiment of the present application. It is to be noted that the battery pack is an electric power source using a secondary battery, and is what we call an assembled battery or the like. The electric vehicle is a vehicle that works (runs) by using a secondary battery as a driving electric power source. As described above, an automobile including a drive source other than a secondary battery (hybrid automobile or the like) may be included. The electric power storage system is a system using a secondary battery as an electric power storage source. For example, in a home electric power storage system, electric power is stored in the secondary battery as an electric power storage source, and the electric power is consumed as needed. Thereby, home electric products and the like become usable. The electric power tool is a tool in which a moving part (for example, a drill or the like) is moved by using a secondary battery as a driving electric power source. The electronic device is a device executing various functions by using a secondary battery as a driving electric power source.

A description will be specifically given of some application examples of the secondary battery. The configurations of the respective application examples explained below are merely examples, and may be changed as appropriate.

[2-1. Battery Pack]

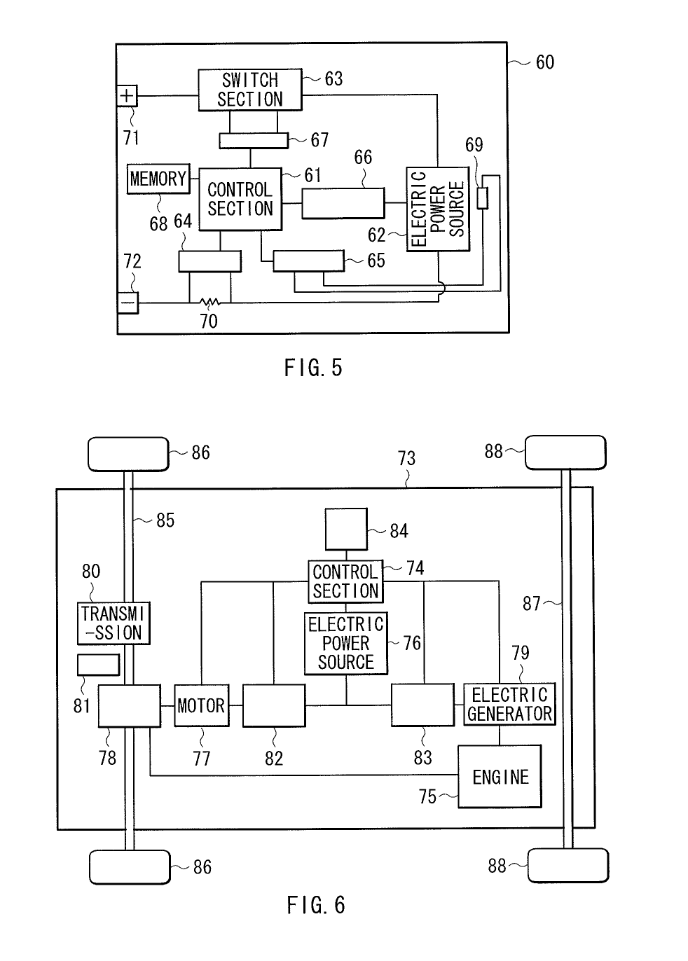

FIG. 5 illustrates a block configuration of a battery pack. For example, as illustrated in FIG. 5, the battery pack includes a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60 made of a plastic material and/or the like.

The control section 61 controls operation of the whole battery pack (including a usage state of the electric power source 62), and includes, for example, a central processing unit (CPU) and/or the like. The electric power source 62 includes one, or two or more lithium ion secondary batteries (not illustrated). The electric power source 62 is, for example, an assembled battery including two or more lithium ion secondary batteries. Connection type thereof may be series-connected type, may be parallel-connected type, or a mixed type thereof. As an example, the electric power source 62 includes six lithium ion secondary batteries connected in a manner of dual-parallel and three-series.

The switch section 63 switches the usage state of the electric power source 62 (whether or not the electric power source 62 is connectable to an external device) according to an instruction of the control section 61. The switch section 63 includes, for example, a charge control switch, a discharge control switch, a charging diode, a discharging diode, and the like (not illustrated). The charge control switch and the discharge control switch are, for example, semiconductor switches such as a field-effect transistor (MOSFET) using metal oxide semiconductor.

The current measurement section 64 measures a current by using the current detection resistance 70, and outputs the measurement result to the control section 61. The temperature detection section 65 measures temperature by using the temperature detection device 69, and outputs the measurement result to the control section 61. The temperature measurement result is used for, for example, a case in which the control section 61 controls charge and discharge at the time of abnormal heat generation or a case in which the control section 61 performs a correction processing at the time of calculating a remaining capacity. The voltage detection section 66 measures a voltage of the lithium ion secondary battery in the electric power source 62, performs analog-to-digital conversion (A/D conversion) on the measured voltage, and supplies the resultant to the control section 61.

The switch control section 67 controls operation of the switch section 63 according to signals inputted from the current measurement section 64 and the voltage measurement section 66.

The switch control section 67 executes control so that a charge current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charge current.

The switch control section 67 executes control so that a discharge current is prevented from flowing in the current path of the electric power source 62 by disconnecting the switch section 63 (discharge control switch) in the case where, for example, a battery voltage reaches an overdischarge detection voltage. Thereby, in the electric power source 62, only charge is allowed to be performed through the charging diode. For example, in the case where a large current flows at the time of discharge, the switch control section 67 blocks the discharge current.

It is to be noted that, in the lithium ion secondary battery, for example, the overcharge detection voltage is 4.20 V±0.05 V, and the over-discharge detection voltage is 2.4 V±0.1 V.

The memory 68 is, for example, an EEPROM as a nonvolatile memory or the like. The memory 68 stores, for example, numerical values calculated by the control section 61 and information of the lithium ion secondary battery measured in a manufacturing step (for example, an internal resistance in the initial state or the like). It is to be noted that, in the case where the memory 68 stores a full charge capacity of the lithium ion secondary battery, the control section 10 is allowed to comprehend information such as a remaining capacity.

The temperature detection device 69 measures temperature of the electric power source 62, and outputs the measurement result to the control section 61. The temperature detection device 69 is, for example, a thermistor or the like.

The cathode terminal 71 and the anode terminal 72 are terminals connected to an external device (for example, a notebook personal computer or the like) driven by using the battery pack, or an external device (for example, a battery charger or the like) used for charging the battery pack. The electric power source 62 is charged and discharged through the cathode terminal 71 and the anode terminal 72.

[2-2. Electric Vehicle]

FIG. 6 illustrates a block configuration of a hybrid automobile as an example of electric vehicles. For example, as illustrated in FIG. 6, the electric vehicle includes a control section 74, an engine 75, an electric power source 76, a driving motor 77, a differential 78, an electric generator 79, a transmission 80, a clutch 81, inverters 82 and 83, and various sensors 84 in a housing 73 made of a metal. In addition, the electric vehicle includes, for example, a front drive axis 85 and a front tire 86 that are connected to the differential 78 and the transmission 80, a rear drive axis 87 and a rear tire 88.

The electric vehicle is runnable by using one of the engine 75 and the motor 77 as a drive source. The engine 75 is a main power source, and is, for example, a petrol engine. In the case where the engine 75 is used as a power source, drive power (torque) of the engine 75 is transferred to the front tire 86 or the rear tire 88 through the differential 78, the transmission 80, and the clutch 81 as drive sections, for example. The torque of the engine 75 is also transferred to the electric generator 79. Due to the torque, the electric generator 79 generates alternating-current electric power. The alternating-current electric power is converted to direct-current electric power through the inverter 83, and the converted power is stored in the electric power source 76. Meanwhile, in the case where the motor 77 as a conversion section is used as a drive source, electric power (direct-current electric power) supplied from the electric power source 76 is converted to alternating-current electric power through the inverter 82. The motor 77 is driven by the alternating-current electric power. Drive power (torque) obtained by converting the electric power by the motor 77 is transferred to the front tire 86 or the rear tire 88 through the differential 78, the transmission 80, and the clutch 81 as the drive sections, for example.

It is to be noted that, alternately, the following mechanism may be adopted. In the mechanism, in the case where speed of the electric vehicle is reduced by an unillustrated brake mechanism, the resistance at the time of speed reduction is transferred to the motor 77 as torque, and the motor 77 generates alternating-current electric power by the torque. It is preferable that the alternating-current electric power be converted to direct-current electric power through the inverter 82, and the direct-current regenerative electric power be stored in the electric power source 76.

The control section 74 controls operation of the whole electric vehicle, and, for example, includes a CPU and the like. The electric power source 76 includes one, or two or more lithium ion secondary batteries (not illustrated). Alternately, the electric power source 76 may be connected to an external electric power source, and electric power may be stored by receiving the electric power from the external electric power source. The various sensors 84 are used, for example, for controlling the number of revolutions of the engine 75 or for controlling opening level of an unillustrated throttle valve (throttle opening level). The various sensors 84 include, for example, a speed sensor, an acceleration sensor, an engine frequency sensor, and the like.

The description has been hereinbefore given of the hybrid automobile as an electric vehicle. However, examples of the electric vehicles may include a vehicle (electric automobile) working by using only the electric power source 76 and the motor 77 without using the engine 75.

[2-3. Electric Power Storage System]

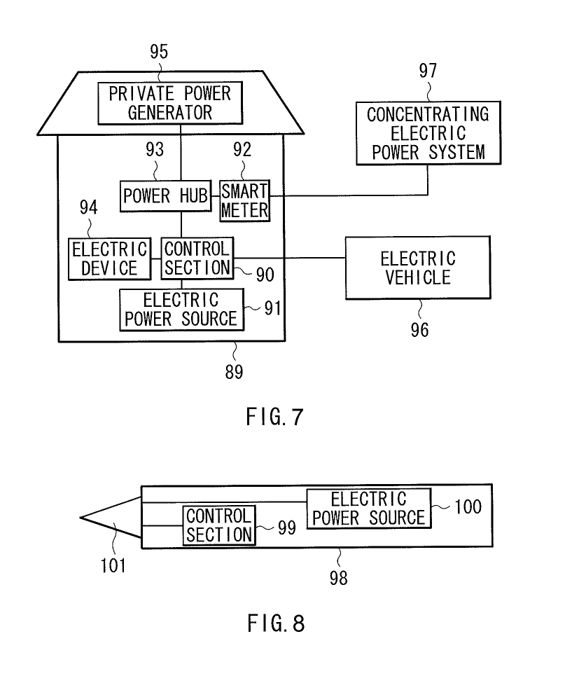

FIG. 7 illustrates a block configuration of an electric power storage system. For example, as illustrated in FIG. 7, the electric power storage system includes a control section 90, an electric power source 91, a smart meter 92, and a power hub 93 inside a house 89 such as a general residence and a commercial building.

In this case, the electric power source 91 is connected to, for example, an electric device 94 arranged inside the house 89, and is connectable to an electric vehicle 96 parked outside of the house 89. Further, for example, the electric power source 91 is connected to a private power generator 95 arranged inside the house 89 through the power hub 93, and is connectable to an external concentrating electric power system 97 thorough the smart meter 92 and the power hub 93.

It is to be noted that, the electric device 94 includes, for example, one, or two or more home electric appliances such as a fridge, an air conditioner, a television, and a water heater. The private power generator 95 is one, or two or more of a solar power generator, a wind-power generator, and the like. The electric vehicle 96 is one, or two or more of an electric automobile, an electric motorcycle, a hybrid automobile, and the like. The concentrating electric power system 97 is, for example, one, or two or more of a thermal power plant, an atomic power plant, a hydraulic power plant, a wind-power plant, and the like.

The control section 90 controls operation of the whole electric power storage system (including a usage state of the electric power source 91), and, for example, includes a CPU and the like. The electric power source 91 includes one, or two or more lithium ion secondary batteries (not illustrated). The smart meter 92 is, for example, an electric power meter compatible with a network arranged in the house 89 demanding electric power, and is communicable with an electric power supplier. Accordingly, for example, while the smart meter 92 communicates with external as needed, the smart meter 92 is allowed to control balance of supply and demand in the house 89 and supply energy effectively and stably.

In the electric power storage system, for example, electric power is stored in the electric power source 91 from the concentrating electric power system 97 as an external electric power source through the smart meter 92 and the power hub 93, and electric power is stored in the electric power source 91 from the private power generator 95 as an independent electric power source through the power hub 93. As needed, the electric power stored in the electric power source 91 is supplied to the electric device 94 or the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 by using the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

The foregoing electric power storage system may be arranged for each household (family unit), or may be arranged for a plurality of households (family units).

[2-4. Electric Power Tool]

FIG. 8 illustrates a block configuration of an electric power tool. For example, as illustrated in FIG. 8, the electric power tool is an electric drill, and includes a control section 99 and an electric power source 100 in a tool body 98 made of a plastic material and/or the like. For example, a drill section 101 as a movable section is attached to the tool body 98 in an operable (rotatable) manner.

The control section 99 controls operation of the whole electric power tool (including a usage state of the electric power source 100), and includes, for example, a CPU and/or the like. The electric power source 100 includes one, or two or more lithium ion secondary batteries (not illustrated). The control section 99 executes control so that electric power is supplied from the electric power source 100 to the drill section 101 as needed according to operation of a not-illustrated operation switch to operate the drill section 101.

### EXAMPLES

Specific Examples according to the embodiment of the present application will be described in detail.

### Examples 1-1 to 1-25

The cylindrical type lithium ion secondary battery illustrated in FIG. 1 and FIG. 2 was fabricated by the following procedure.

In forming the cathode 21, 91 parts by mass of a cathode active material (LiCoO₂), 3 parts by mass of a cathode binder (polyvinylidene fluoride: PVDF), and 6 parts by mass of a cathode electric conductor (graphite) were mixed to obtain a cathode mixture. Subsequently, the cathode mixture was dispersed in an organic solvent (N-methyl-2-pyrrolidone: NMP) to obtain a paste cathode mixture slurry. Subsequently, both surfaces of the cathode current collector 21A (strip-shaped aluminum foil being 12 μm thick) were coated with the cathode mixture slurry uniformly by using a coating device, which was dried to form the cathode active material layer 21B. Finally, the cathode active material layer 21B was compression-molded by using a roll pressing machine.

In forming the anode 22, 97 parts by mass of an anode active material (artificial graphite as a carbon material) and 3 parts by mass of an anode binder (PVDF) were mixed to obtain an anode mixture. Subsequently, the anode mixture was dispersed in NMP to obtain a paste anode mixture slurry. Subsequently, both surfaces of the anode current collector 22A (strip-shaped electrolytic copper foil being 15 μm thick) were coated with the anode mixture slurry uniformly by using a coating device, which was dried to form the anode active material layer 22B. Finally, the anode active material layer 22B was compression-molded by using a roll pressing machine.

In preparing an electrolytic solution as a liquid electrolyte, an electrolyte salt (LiPF₆) was dissolved in a solvent (ethylene carbonate (EC) and dimethyl carbonate (DMC)). After that, as needed, an allene compound and the like was added thereto. In this case, the composition of the solvent was EC:DMC=30:70 at a weight ratio, and the content of the electrolyte salt with respect to the solvent was 1.2 mol/kg. Types and contents of the allene compound and the like are as illustrated in Table 1. In this case, for comparison, an ethylene compound represented by Formula (3) described below was used instead of the allene compound as needed.

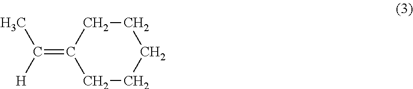

In assembling the secondary battery, the cathode lead 25 made of Al was welded to the cathode current collector 21A, and the anode lead 26 made of Ni was welded to the anode current collector 22A. Subsequently, the cathode 21 and the anode 22 were layered with the separator 23 in between and were spirally wound. After that, the winding end section was fixed by using an adhesive tape to form the spirally wound electrode body 20. The separator 23 was a microporous polypropylene film (thickness: 25 μm). Subsequently, the center pin 24 was inserted in the center of the spirally wound electrode body 20. Subsequently, while the spirally wound electrode body 20 was sandwiched between the pair of insulating plates 12 and 13, the spirally wound electrode body 20 was contained in the iron battery can 11 plated with Ni. In this case, the tip end of the cathode lead 25 was welded to the safety valve mechanism 15, and the tip end of the anode lead 26 was welded to the battery can 11. Subsequently, the electrolytic solution was injected into the battery can 11 by a depressurization method, and the separator 23 was impregnated with the electrolytic solution. Finally, at the open end of the battery can 11, the battery cover 14, the safety valve mechanism 15, and the PTC device 16 were fixed by being caulked with the gasket 17. The cylindrical type secondary battery was thereby completed. In forming the secondary battery, lithium metal was prevented from being precipitated on the anode 22 at the time of full charge by adjusting the thickness of the cathode active material layer 21B.

As characteristics of the secondary battery, cycle characteristics and conservation characteristics thereof were examined in a high temperature environment. Results illustrated in Table 1 were obtained.

In examining the cycle characteristics, two cycles of charge and discharge were performed on the secondary battery in the ambient temperature environment (23 deg C.), and a discharge capacity was measured. After that, the secondary battery was further charged and discharged until the total number of cycles reached 300 in the high temperature atmosphere (50 deg C.), and a discharge capacity was measured. From these results, cycle retention ratio (%)=(discharge capacity at the 300th cycle/discharge capacity at the second cycle)×100 was calculated. At the time of charge, constant current and constant voltage charge was performed at a current of 0.2 C until the voltage reached the upper limit voltage of 4.2 V, and further charge was performed at a constant voltage (upper limit voltage) until the current reached 0.05 C. At the time of discharge, constant current discharge was performed at a current of 0.2 C until the voltage reached the final voltage of 3 V. “0.2 C” and “0.05 C” are respectively current values at which the battery capacity (theoretical capacity) is discharged up in 5 hours and 20 hours.

In examining the conservation characteristics, under conditions similar to those in the case of examining the cycle characteristics, two cycles of charge and discharged were performed on the secondary battery in the ambient temperature environment (23 deg C.), and a discharge capacity was measured. After that, while the secondary battery was charged again, the secondary battery was stored in a constant temperature bath (60 deg C.) for 10 days. After that, the secondary battery was discharged again in the ambient temperature environment (23 deg C.), and a discharge capacity was measured. From these results, conservation retention ratio (%)=(discharge capacity after conservation/discharge capacity before conservation)×100 was calculated. At the time of recharge, constant current and constant voltage charge was performed for 4 hours at a current of 0.5 C until the voltage reached the upper limit voltage of 4.2 V. At the time of re-discharge, constant current discharge was performed at a current of 0.2 C until the voltage reached the final voltage of 3 V.

TABLE 1
Anode active material: artificial graphite

| | Allene compound | | | |
|---|---|---|---|---|
| | and the like | | Cycle | Conservation |
| | | Content | retention ratio | retention ratio |
| Example | Type | (wt %) | (%) | (%) |
| 1-1 | Formula (1-1) | 0.5 | 85 | 75 |
| 1-2 | | 1 | 89 | 83 |
| 1-3 | Formula (1-2) | 0.05 | 76 | 76 |
| 1-4 | | 0.1 | 82 | 77 |
| 1-5 | | 0.3 | 89 | 78 |
| 1-6 | | 0.5 | 90 | 80 |
| 1-7 | | 1 | 89 | 82 |
| 1-8 | | 2 | 88 | 82 |
| 1-9 | Formula (1-3) | 0.5 | 82 | 80 |
| 1-10 | | 1 | 88 | 85 |
| 1-11 | Formula (1-4) | 0.05 | 80 | 75 |
| 1-12 | | 0.1 | 85 | 76 |
| 1-13 | | 0.3 | 92 | 78 |
| 1-14 | | 0.5 | 93 | 79 |
| 1-15 | | 1 | 90 | 83 |
| 1-16 | | 2 | 88 | 84 |
| 1-17 | Formula (1-5) | 0.05 | 78 | 74 |
| 1-18 | | 0.1 | 83 | 75 |
| 1-19 | | 0.3 | 90 | 77 |
| 1-20 | | 0.5 | 90 | 78 |
| 1-21 | | 1 | 89 | 81 |
| 1-22 | | 2 | 87 | 82 |
| 1-23 | — | — | 62 | 68 |
| 1-24 | Formula (3) | 0.5 | 62 | 70 |
| 1-25 | | 1 | 60 | 72 |

In the case where the carbon material (artificial graphite) was used as an anode active material, if the electrolytic solution contained the allene compound, a high cycle retention ratio and a high conservation retention ratio were obtained.

More specifically, the case in which the electrolytic solution did not contain an additive such as the allene compound (Example 1-23) is regarded as the standard. In the case where the ethylene compound having only one carbon-carbon double bond was used as an additive added to the electrolytic solution (Examples 1-24 and 1-25), although the conservation retention ratios were slightly higher than that of the foregoing standard, the cycle retention ratios were equal to or less than that of the foregoing standard. Meanwhile, in the case where the allene compound having adjacent two carbon-carbon double bonds was used (Examples 1-1 to 1-22), both the cycle retention ratios and the conservation retention ratios were largely higher than those of the foregoing standard. Further, the conservation retention ratios obtained in the case of using the allene compound were further higher than the conservation retention ratios obtained in the case of using the ethylene compound.

The foregoing results show the following. That is, in the case where the highly reactive allene compound is used, as described above, the polymer compound originated in the allene compound is grown in three-dimensional directions. Therefore, in this case, the physical intensity and the chemical durability of the SEI film are more significantly improved than in the case of using the ethylene compound. Thereby, even if the secondary battery is charged, discharged, and stored in a high temperature environment, a decomposition reaction of the electrolytic solution is significantly suppressed. Therefore, lowering of the cycle retention ratio and the conservation retention ratio is suppressed as well. As seen in the result in which not only the conservation retention ratio but also the cycle retention ratio was increased, such a function of suppressing decomposition of the electrolytic solution is not obtained in the case of using the ethylene compound, and is an advantage that tends to be obtained in the case of using the allene compound.

In particular, in the case where the content of the allene compound in the electrolytic solution was from 0.05 wt % to 2 wt % both inclusive, high cycle retention ratios and high conservation retention ratios were obtained. In this case, in the case where X4 in Formula (2) was an alkoxy group or a borate ester group, or in the case where the content of the allene compound in the electrolytic solution was from 0.3 wt % to 1 wt % both inclusive, the cycle retention ratio and the conservation retention ratio were more increased.

### Examples 2-1 to 2-23

Secondary batteries were fabricated by a procedure similar to that of Examples 1-1 to 1-23 except that a metal-based material (silicon) was used instead of the carbon material as an anode active material as illustrated in Table 2, and characteristics thereof were examined.

In the case where the anode 22 was formed, silicon was deposited on both surfaces of the anode current collector 22A by using an electron beam evaporation method to form the anode active material layer 22B. In this case, the deposition steps were repeated for 10 times so that the thickness of a single surface side of the anode active material layer 22B became 6 μm.

TABLE 2
Anode active material: silicon

| | Allene compound | | | |
|---|---|---|---|---|
| | and the like | | Cycle | Conservation |
| | | Content | retention ratio | retention ratio |
| Example | Type | (wt %) | (%) | (%) |
| 2-1 | Formula (1-1) | 0.5 | 83 | 71 |
| 2-2 | | 1 | 85 | 77 |
| 2-3 | Formula (1-2) | 0.05 | 74 | 70 |
| 2-4 | | 0.1 | 78 | 72 |
| 2-5 | | 0.3 | 85 | 73 |
| 2-6 | | 0.5 | 85 | 78 |
| 2-7 | | 1 | 84 | 80 |
| 2-8 | | 2 | 82 | 81 |
| 2-9 | Formula (1-3) | 0.05 | 76 | 72 |
| 2-10 | | 0.1 | 82 | 73 |
| 2-11 | | 0.3 | 86 | 80 |
| 2-12 | | 0.5 | 88 | 82 |
| 2-13 | | 1 | 89 | 84 |
| 2-14 | | 2 | 88 | 84 |
| 2-15 | Formula (1-4) | 0.05 | 75 | 70 |
| 2-16 | | 0.1 | 80 | 72 |
| 2-17 | | 0.3 | 85 | 78 |
| 2-18 | | 0.5 | 86 | 80 |
| 2-19 | | 1 | 85 | 81 |
| 2-20 | | 2 | 82 | 81 |
| 2-21 | Formula (1-5) | 0.5 | 84 | 79 |
| 2-22 | | 1 | 85 | 79 |
| 2-23 | — | — | 68 | 64 |

In the case where the metal-based material (silicon) was used as an anode active material, results similar to those in the case of using the carbon material (Table 1) were obtained as well. That is, in the case where the electrolytic solution contained the allene compound, a high cycle retention ratio and a high conservation retention ratio were obtained.

From the results of Table 1 and Table 2, it was confirmed that in the case where the electrolytic solution contained the allene compound having the tetravalent skeleton represented by Formula (1), superior battery characteristics were obtained.

The present application has been described with reference to the embodiment and the examples. However, the present application is not limited to the examples described in the embodiment and the Examples, and various modifications may be made. For example, the cathode active material of the present application is similarly applicable to a lithium ion secondary battery in which an anode capacity includes a capacity by inserting and extracting lithium ions and a capacity associated with precipitation and dissolution of Li metal, and the anode capacity is expressed by the sum of these capacities. In this case, a chargeable capacity of an anode material is set to a smaller value than that of a discharge capacity of a cathode.

Further, in the embodiment and the Examples, the description has been given with the specific example in which the battery structure is the cylindrical type or the laminated film type, and with the specific example in which the battery device has the spirally wound structure. However, applicable structures are not limited thereto. The lithium ion secondary battery of the present application is similarly applicable to a battery having other battery structure such as a coin type battery, a square type battery, and a button type battery, or a battery in which the battery device has other structure such as a laminated structure.

It is possible to achieve at least the following configurations from the above-described exemplary embodiment and the modifications of the disclosure.

(1) A secondary battery including:

a cathode;

an anode; and

an electrolytic solution, wherein

the electrolytic solution includes an allene compound having a tetravalent skeleton represented by Formula (1) described below.

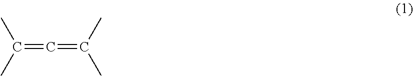

(2) The secondary battery according to (1), wherein the allene compound is represented by Formula (2) described below,

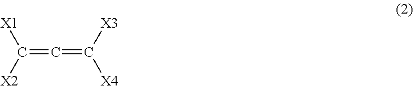

where each of X1 to X4 is one of a hydrogen group (—H), a halogen group (—F, —Cl, —Br, or —I), an alkyl group, a halogenated alkyl group, an aryl group, a halogenated aryl group, a hydroxyl group (—OH), an alkoxy group (—ORO, an aldehyde group (—CHO), a carboxyl group (—COOH), an acid halide group (—COF, —COCl, —COBr, or —COI), an amino group (—NR2₂), a thiol group (—SH), a thioalkoxy group (—SR1), a sulfonate group (—SO₃H), a cyano group (—CN), an isocyanate group (—NCO), a thioisocyanate group (—NCS), an ester carbonate group (—OCOOR1), a carboxylic ester group (—COOR1), a carboxylic anhydride group (—COOCOR1), an amido group (—NRCOR1), a sulfonic ester group (—SO₃R1), a sulfonic anhydride group (—SO₂OSO₂R1), a sulfuric ester group (—OSO₂OR1), a carbamic ester group (—NHCOOR1), a silyl ether group (—OSiR1₃), a borate ester group (—B(OR1)₂), a phosphoric ester group (—OP(═O)(OR1)₂), a phosphorous ester group (—OP(OR1)₂), a titanate ester group (—OTi(OR1)₃), and an aluminate ester group (—OAl(OR1)₂); arbitrary two or more of the X1 to the X4 are allowed to be bonded with each other and arbitrary two or more of the plurality of R1s are allowed to be bonded with each other; the R1 is an alkyl group; and the R2 is one of a hydrogen group and an alkyl group.
(3) The secondary battery according to (2), wherein each of the X1 to the X3 is one of a hydrogen group, a halogen group, an alkyl group, a halogenated alkyl group, an aryl group, and a halogenated aryl group, and

the X4 is one of a hydroxyl group, an alkoxy group, an aldehyde group, a carboxyl group, an acid halide group, an amino group, a thiol group, a thioalkoxy group, a sulfonate group, a cyano group, an isocyanate group, a thioisocyanate group, an ester carbonate group, a carboxylic ester group, a carboxylic anhydride group, an amido group, a sulfonic ester group, a sulfonic anhydride group, a sulfuric ester group, a carbamic ester group, a silyl ether group, a borate ester group, a phosphoric ester group, a phosphorous ester group, a titanate ester group, and an aluminate ester group.

(4) The secondary battery according to (3), wherein the X4 is one of an alkoxy group, an acid halide group, a cyano group, an isocyanate group, an ester carbonate group, a carboxylic anhydride group, a sulfonic ester group, a sulfonic anhydride group, a silyl ether group, and a borate ester group.
(5) The secondary battery according to any one of (1) to (4), wherein a content of the allene compound in the electrolytic solution is from about 0.05 weight percent to about 2 weight percent both inclusive.
(6) The secondary battery according to (5), wherein the content of the allene compound in the electrolytic solution is from about 0.3 weight percent to about 1 weight percent both inclusive.
(7) The secondary battery according to any one of (1) to (6), the secondary battery is a lithium ion secondary battery.
(8) An electrolytic solution including an allene compound having a tetravalent skeleton represented by Formula (1) described below.

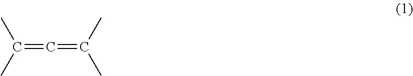

(9) A battery pack including:

the secondary battery according to any one of (1) to (7);

a control section controlling a usage state of the secondary battery; and

a switch section switching the usage state of the secondary battery according to an instruction of the control section.

(10) An electric vehicle including:

the secondary battery according to any one of (1) to (7);

a conversion section converting electric power supplied from the secondary battery to drive power;

a drive section operating according to the drive power; and

a control section controlling a usage state of the secondary battery.

(11) An electric power storage system including:

the secondary battery according to any one of (1) to (7);

one, or two or more electric devices; and

a control section controlling electric power supply from the secondary battery to the electric device.

(12) An electric power tool including:

the secondary battery according to any one of (1) to (7); and

a movable section being supplied with electric power from the secondary battery.

(13) An electronic device, the electronic device being supplied with electric power from the secondary battery according to any one of (1) to (7).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a cathode;
an anode; and
an electrolytic solution, wherein
the electrolytic solution includes an allene compound having a tetravalent skeleton represented by Formula (1) described below.

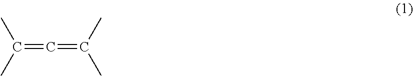

2. The secondary battery according to claim 1, wherein the allene compound is represented by Formula (2) described below, 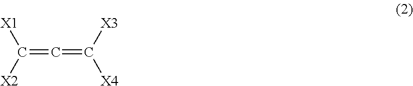
where each of X1 to X4 is one of a hydrogen group (—H), a halogen group (—F, —Cl, —Br, or —I), an alkyl group, a halogenated alkyl group, an aryl group, a halogenated aryl group, a hydroxyl group (—OH), an alkoxy group (—ORO, an aldehyde group (—CHO), a carboxyl group (—COOH), an acid halide group (—COF, —COCl, —COBr, or —COI), an amino group (—NR2₂), a thiol group (—SH), a thioalkoxy group (—SR1), a sulfonic acid group (—SO₃H), a cyano group (—CN), an isocyanate group (—NCO), a thioisocyanate group (—NCS), a carbonate ester group (—OCOOR1), a carboxylic ester group (—COOR1), a carboxylic anhydride group (—COOCOR1), an amido group (—NRCOR1), a sulfonic ester group (—SO₃R1), a sulfonic anhydride group (—SO₂OSO₂R1), a sulfuric ester group (—OSO₂OR1), a carbamic ester group (—NHCOOR1), a silyl ether group (—OSiR1₃), a borate ester group (—B(OR1)₂), a phosphoric ester group (—OP(═O)(OR1)₂), a phosphorous ester group (—OP(OR1)₂), a titanate ester group (—OTi(OR1)₃), and an aluminate ester group (—OAl(OR1)₂); arbitrary two or more of the X1 to the X4 are allowed to be bonded with each other and arbitrary two or more of the plurality of R1s are allowed to be bonded with each other; the R1 is an alkyl group; and the R2 is one of a hydrogen group and an alkyl group.

3. The secondary battery according to claim 2, wherein each of the X1 to the X3 is one of a hydrogen group, a halogen group, an alkyl group, a halogenated alkyl group, an aryl group, and a halogenated aryl group, and
the X4 is one of a hydroxyl group, an alkoxy group, an aldehyde group, a carboxyl group, an acid halide group, an amino group, a thiol group, a thioalkoxy group, sulfonic acid group, a cyano group, an isocyanate group, a thioisocyanate group, a carbonate ester group, a carboxylic ester group, a carboxylic anhydride group, an amido group, a sulfonic ester group, a sulfonic anhydride group, a sulfuric ester group, a carbamic ester group, a silyl ether group, a borate ester group, a phosphoric ester group, a phosphorous ester group, a titanate ester group, and an aluminate ester group.

4. The secondary battery according to claim 3, wherein the X4 is one of an alkoxy group, an acid halide group, a cyano group, an isocyanate group, a carbonate ester group, a carboxylic anhydride group, a sulfonic ester group, a sulfonic anhydride group, a silyl ether group, and a borate ester group.

5. The secondary battery according to claim 1, wherein a content of the allene compound in the electrolytic solution is from about 0.05 weight percent to about 2 weight percent both inclusive.

6. The secondary battery according to claim 5, wherein the content of the allene compound in the electrolytic solution is from about 0.3 weight percent to about 1 weight percent both inclusive.

7. The secondary battery according to claim 1, the secondary battery is a lithium ion secondary battery.

8. An electrolytic solution comprising an allene compound having a tetravalent skeleton represented by Formula (1) described below.

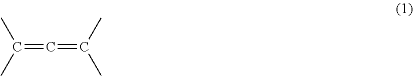

9. A battery pack comprising:
a secondary battery;
a control section controlling a usage state of the secondary battery; and
a switch section switching the usage state of the secondary battery according to an instruction of the control section, wherein
the secondary battery includes a cathode, an anode, and an electrolytic solution, and
the electrolytic solution includes an allene compound having a tetravalent skeleton represented by Formula (1) described below.

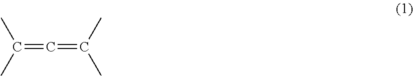

10. An electric vehicle comprising:
a secondary battery;
a conversion section converting electric power supplied from the secondary battery to drive power;
a drive section operating according to the drive power; and
a control section controlling a usage state of the secondary battery, wherein
the secondary battery includes a cathode, an anode, and an electrolytic solution, and
the electrolytic solution includes an allene compound having a tetravalent skeleton represented by Formula (1) described below.

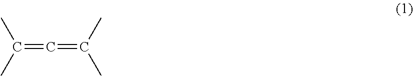

11. An electric power storage system comprising:
a secondary battery;
one, or two or more electric devices; and
a control section controlling electric power supply from the secondary battery to the electric device, wherein
the secondary battery includes a cathode, an anode, and an electrolytic solution, and
the electrolytic solution includes an allene compound having a tetravalent skeleton represented by Formula (1) described below.

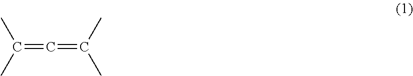

12. An electric power tool comprising:
a secondary battery; and
a movable section being supplied with electric power from the secondary battery, wherein
the secondary battery includes a cathode, an anode, and an electrolytic solution, and
the electrolytic solution includes an allene compound having a tetravalent skeleton represented by Formula (1) described below.

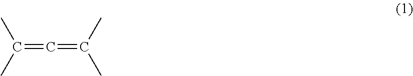

13. An electronic device, the electronic device being supplied with electric power from a secondary battery, wherein
the secondary battery includes a cathode, an anode, and an electrolytic solution, and
the electrolytic solution includes an allene compound having a tetravalent skeleton represented by Formula (1) described below. [chemical structure]
